(19) United States
(12) Patent Application Publication
(10) Pub. No.: US 2025/0357845 A1
(43) Pub. Date: Nov. 20, 2025

(54) METHOD AND APPARATUS FOR CHARGING BOOTSTRAP CAPACITOR

(71) Applicant: TEXAS INSTRUMENTS INCORPORATED, Dallas, TX (US)

(72) Inventor: Pavol Balaz, San Francisco, CA (US)

(21) Appl. No.: 19/188,869

(22) Filed: Apr. 24, 2025

Related U.S. Application Data
(60) Provisional application No. 63/647,659, filed on May 15, 2024.

(51) Int. Cl. H02M 1/08; H02M 1/00; H02M 3/156

(52) U.S. Cl. CPC H02M 1/08; H02M 1/0006; H02M 3/156

(57) ABSTRACT

An apparatus comprising a driver circuit having a driver supply terminal, a driver reference terminal, and a driver output. The apparatus further comprises a transistor coupled between a power terminal and the driver supply terminal; and a transistor control circuit coupled between a control terminal of the transistor and at least one of the driver supply terminal or the driver reference terminal.

### CLAIM OF PRIORITY

This application claims priority to U.S. Provisional Application No. 63/647,659 filed May 15, 2024, titled “Bootstrap Capacitor Recharge for a Switching Power Converter,” which is incorporated by reference in its entirety.

### BACKGROUND

A switching power converter with a high side n-type switch may use a bootstrap capacitor to drive the high side n-type switch to turn on the n-type switch. The bootstrap capacitor can be recharged when the high side switch is turned off. The charging of the bootstrap capacitor can be controlled via a switch (e.g., a pass transistor), and the charging may result in power loss due to power dissipation at the switch.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIGS. 1, 2, and 3 are schematics illustrating a power converter with circuitry to charge a bootstrap capacitor, in accordance with at least one example.

FIG. 4 is a plot illustrating a timing diagram of signals of the power converter to charge the bootstrap capacitor, in accordance with at least one example.

FIG. 5 is a schematic of a system comprising a DC-DC buck power converter with the circuitry to charge a bootstrap capacitor, in accordance with at least one example.

FIG. 6 is a schematic of a system comprising a DC-DC boost power converter with the circuitry to charge a bootstrap capacitor, in accordance with at least one example.

FIG. 7 is a flowchart of a method of charging the bootstrap capacitor, in accordance with at least one example.

### SUMMARY

In at least one example, an apparatus comprises a driver circuit having a driver supply terminal, a driver reference terminal, and a driver output. The apparatus further comprises a transistor coupled between a power terminal and the driver supply terminal. The apparatus further comprises a transistor control circuit coupled between a control terminal of the transistor and at least one of the driver supply terminal or the driver reference terminal.

In at least one example, a system comprises: a DC-DC converter; an inductor coupled to the DC-DC converter; a load capacitor coupled to the inductor; and a load coupled to the load capacitor. In at least one example, the DC-DC converter comprises a driver circuit having a driver supply terminal, a driver reference terminal, and a driver output. In at least one example, the DC-DC converter further comprises a transistor coupled between a power terminal and the driver supply terminal. The DC-DC converter further comprises a transistor control circuit coupled between a control terminal of the transistor and at least one of the driver supply terminal or the driver reference terminal. The DC-DC converter further comprises a high switch coupled between the power terminal and the driver reference terminal, wherein the driver output is coupled to a control input of the high side switch.

In at least one example, a method comprises responsive to a state transition of a capacitor terminal of a capacitor, setting a resistance across a transistor to a first value to charge the capacitor via the transistor. In at least one example, the method further comprises responsive to the capacitor terminal being at a steady state, setting a resistance across the transistor to a second value, in which the second value is higher than the first value.

### DETAILED DESCRIPTION

As described above, the charging of the bootstrap capacitor can be controlled via a switch (e.g., a pass transistor), and the charging may result in power loss due to power dissipation at the switch. The power loss may increase with a large voltage drop across the switch (e.g., a large drain-to-source voltage (VDS) across the pass transistor). In some examples, the bootstrap capacitor is coupled between a switching terminal and a boot terminal, where the switching terminal is a common terminal between the high side n-type switch and the low-side n-type switch, the boot terminal is coupled to a supply terminal of a driver circuit that drives the high side n-type switch, and a reference terminal of the driver circuit is coupled to the switching terminal. The pass transistor is coupled between a power terminal and the boot terminal, where the power terminal can be a power input of a switching power converter.

In some example, a bootstrap charging circuit that controls the charging of the bootstrap capacitor can include a transistor control circuit, which can include one or more voltage generator circuits (e.g., diodes, resistors), having an output coupled to a gate of the pass transistor and a sense terminal (or reference terminal) coupled to at least one of the switching terminal or the boot terminal. The voltage generator circuit that can generate a relatively high gate source voltage (VGS) for the pass transistor responsive to a voltage transition at the sense terminal. The voltage transition can occur shortly after the high side switch is turned off when the voltage of the switching terminal is still close to the voltage on the power terminal. Accordingly, the control circuit can increase the overdrive of the pass transistor and increase/maximize the flow of charge through the pass transistor when the voltage across the pass transistor is still low, thereby reducing/minimizing the power loss from the pass transistor and allows for efficient charging of the bootstrap capacitor.

In at least one example, the voltage generator circuits can include a first clamp circuit and a second clamp circuit. The first clamp circuit can include multiple rectifying devices (e.g., diodes, a Zener diode, diode-connected transistors, etc.) coupled in series. The first clamp circuit can be coupled between the output of the voltage generator circuit and the sense terminal, which can be coupled to the boot terminal. The first clamp circuit can receive a current from the sense terminal caused by the voltage transition (e.g., due to the boot terminal voltage transitioning together with the switching terminal voltage), and provide a pre-determined VGS based on, for example, a sum of the forward voltages of the rectifying devices, responsive to the current. The first clamp circuit can also clamp/limit the VGS at the pre-determined value during the voltage transition, thereby providing alternating current (AC) clamping (e.g., clamping against a fast VGS transition), to reduce voltage stress for the pass transistor and improve the reliability of the pass transistor.

Also, the second clamp circuit can include a Zener diode and a resistor coupled in series between the gate of the pass transistor and the boot terminal. The second clamp circuit can clamp the gate voltage of the pass transistor against the switching terminal, which in turn can clamp the voltage difference between the switching terminal and the boot terminal, when the voltage at the switching terminal is not transitioning (e.g., after the high side switch is off), thereby providing direct current (DC) clamping. Such arrangements can limit the voltage across the bootstrap capacitor and supply voltage provided to the driver circuit. The second clamp circuit may provide a high impedance than the first clamp circuit, so that it draws less current than the first clamp circuit during the voltage transition. The first clamp circuit can be largely inactive when the voltage at the switching terminal is not transitioning.

While various examples are described herein for an n-type buck converter, the bootstrap charging circuit can be used to apply for a non-synchronous switching converter, in a GaN half bridge, an n-type half bridge, a boost converter, or a buck-boost converter.

Here, the same reference numbers or other reference designators are used in the drawings to designate the same or similar (either by function and/or structure) features.

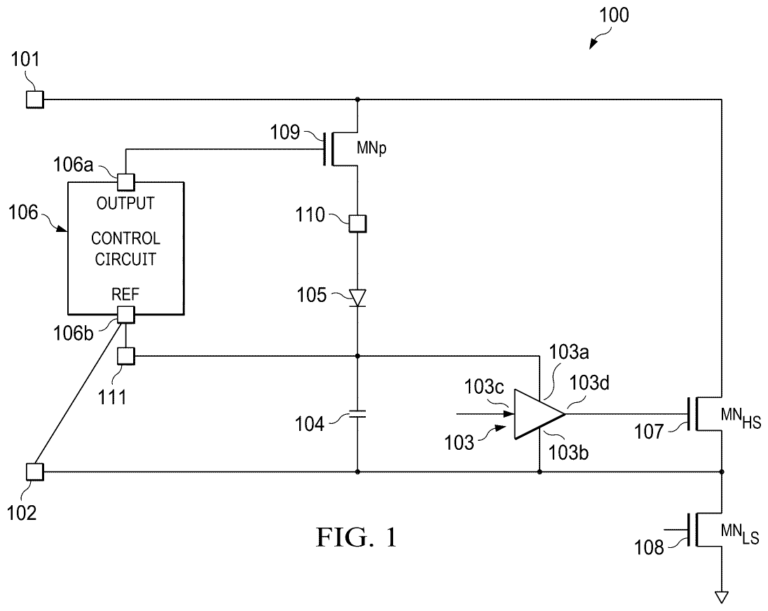

FIGS. 1-3 are schematics illustrating a power converter 100 with circuitry to charge a bootstrap capacitor, in accordance with at least one example. Referring to FIG. 1 in at least one example, power converter 100 comprises a power terminal 101, a switching terminal 102, a driver 103, a bootstrap capacitor 104, a diode 105, a control circuit 106, an n-type high side (HS) switch MNHS 107, an n-type low side (LS) switch MNLS 108, an n-type pass transistor MNp 109, a current terminal 110, and a boot terminal 111. In at least one example, HS switch MNHS 107, LS switch MNLS 108, and pass transistor MNp 109 are one of GaN field effect transistor (FET), a laterally diffused metal oxide semiconductor (LDM OS) FET, a drain extended n-type metal oxide semiconductor (DENMOS) FET, or a complementary MOS (CM OS) based NM OS.

In at least one example, driver 103 has a driver supply terminal 103a and a driver reference terminal 103b, where driver supply terminal 103a is coupled to boot terminal 111 and driver reference terminal 103b is coupled to switching terminal 102. Driver 103 receives a modulated signal (e.g., a pulse modulated, or a frequency modulated signal) at driver input 103c and provides a controlling output at driver output 103d to control HS switch MN_{HS} 107. In this example, HS switch MN_{HS} 107 is coupled in series with LS switch MN_{LS} 108 between power terminal 101 and ground, where a common node between HS switch MN_{HS} 107 and LS switch MN_{LS} 108 is switching terminal 102. Bootstrap capacitor 104 has a top plate coupled to boot terminal 111 and a bottom plate coupled to switching terminal 102. Bootstrap capacitor 104 can store charge and maintain a voltage difference between boot terminal 111 and switching terminal 102, so that the voltage at boot terminal 111 exceeds the voltage at switching terminal 102 by the voltage difference, thereby providing a bootstrapped supply voltage to driver 103. With such arrangements, driver 103 can provide a VGS voltage for HS switch MN_{HS} 107 that exceeds the threshold voltage of HS switch MN_{HS} 107 to enable the HS switch.

Due to the bootstrapping of the boot terminal voltage by bootstrap capacitor 104, the voltage at boot terminal 111 can exceed the voltage at current terminal 110 when, for example, HS switch MN_{HS} 107 is enabled. In at least one example, diode 105 is coupled between boot terminal 111 and current terminal 110 to block current from flowing from boot terminal 111 to transistor MNp 109 via current terminal 110 when the voltage at boot terminal 111 exceeds the voltage at current terminal 110. Diode 105 can be a discrete component or body diode of a transistor.

In at least one example, control circuit 106 has a control terminal 106a and a sense terminal (or a reference terminal) 106b, where control terminal 106b is coupled to a control terminal (e.g., gate) of pass transistor MNp 109, while reference terminal 106b is coupled to boot terminal 111 and switching terminal 102. Switching terminal 102 is also coupled to the bottom plate of bootstrap capacitor 104, driver reference terminal 103b, source terminal of HS switch MN_{HS} 107, and drain terminal of LS switch MN_{LS} 108. Boot terminal 111 is also coupled to the top plate of bootstrap capacitor 104, diode 105, and driver supply terminal 103a.

In at least one example, control circuit 106 is configurable to set a voltage between control terminal 106a and current terminal 110 of pass transistor MNp 109 (e.g., a VGS voltage of pass transistor MNp 109) to a first value responsive to a voltage a at least one of boot terminal 111 (coupled to driver supply terminal 103a) or switching terminal 102 (coupled to the driver reference terminal 103b) being in a changing state (e.g., AC state). The first VGS value can exceed the threshold voltage of pass transistor MNp 109 by a certain margin to increase the overdrive a to facilitate flow of charge when the voltage across pass transistor MNp 109 is relatively low and to reduce power loss, while the first VGS value is maintained/clamped within a voltage stress limit of pass transistor MNp 109 to avoid overstressing the transistor and degrading the reliability.

In at least one example, control circuit 106 is further configurable to set the VGS voltage to a second value, and set the voltage across the bootstrap capacitor 104 to a third value, when the voltage at the at least one of boot terminal 111 or switching terminal 102 is in a steady state (e.g., DC state), such as when the high side switch is off. With such arrangements, control circuit 106 can limit the voltage across the bootstrap capacitor.

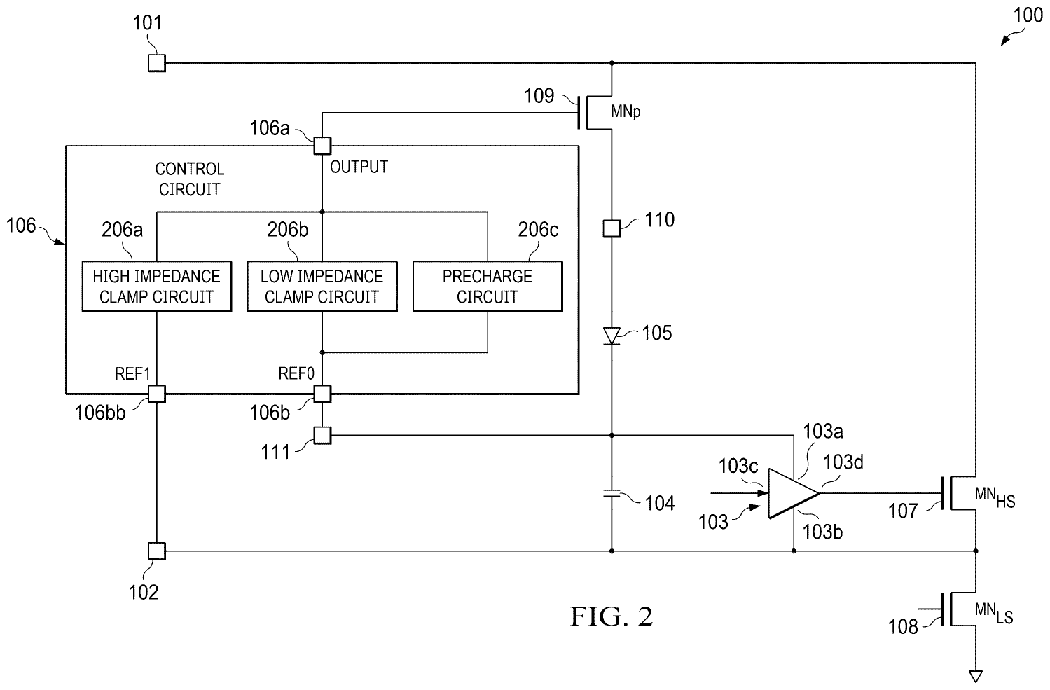

FIG. 2 illustrates examples of internal components of control circuit 106. Referring to FIG. 2 in at least one example, control circuit 106 includes multiple voltage generator circuits including a high impedance clamp circuit 206a, a low impedance clamp circuit 206b, and precharge circuit 206c. Low impedance clamp circuit 206b is coupled between control terminal 106a and reference terminal 106b, which is coupled to boot terminal 111 (as shown in FIG. 2) or switching terminal 102. Low impedance clamp circuit 206b can set the voltage between control terminal 106a and current terminal 110 of pass transistor MNp 109 (the VGS voltage of pass transistor MNp 109) to the first value responsive to a voltage at boot terminal 111 or switching terminal 102 (or both) being in a changing/transition state (e.g., AC state), where a transient current can flow from boot terminal 111 through low impedance clamp circuit 206b and generate the voltage having the first value. With such arrangements, the overdrive voltage of pass transistor MNp 109 can be increased when the voltage across pass transistor MNp 109 (VDS) remain low, to facilitate charge transfer to bootstrap capacitor 104 and reduce power loss caused by the charge transfer.

In at least one example, high impedance clamp circuit 206a is coupled between control terminal 106a and a reference terminal 106bb, which is coupled to switching terminal 102 (as shown in FIG. 2) or boot terminal 111 in other examples. High impedance clamp circuit 206a can have a higher impedance than low impedance clamp circuit 206b to ensure that majority of the transient current flows through low impedance clamp circuit 206b during the voltage transition at boot terminal 111 and/or switching terminal 102. When a voltage at switching terminal 102 or boot terminal 111 (or both) is in a steady state and after the charging of bootstrap capacitor 104 completes, low impedance clamp circuit 206b can be disabled, and any current that flows from boot terminal 111/switching terminal 102 can flow through high impedance clamp circuit 206a and generate the voltage having the second value. With such arrangements, high impedance clamp circuit 206a can clamp the gate voltage of pass transistor MNp 109 with respect to the switching terminal, which in turn can clamp the voltage across bootstrap capacitor 104.

In at least one example, precharge circuit 206c is coupled between control terminal 106a and reference terminal 106b. Precharge circuit 206c can precharge control terminal 106a to a certain voltage when the voltage on switching terminal 102 is at input power supply level Vin (e.g., 60V), and the voltage boot terminal 111 exceeds Vin, such as when HS switch MN_{HS} 107 being turned on and LS switch MN_{LS} 108 being turned off. For example, precharge circuit 206c can set a voltage of control terminal 106a to be one diode forward voltage below the voltage of boot terminal 111, which can turn on pass transistor MNp 109 and bring the voltage of current terminal 110 to the voltage on power supply terminal 101 (Vin). Such arrangements can reduce the voltage across diode 105 and allow diode 105 to be implemented in a low voltage device.

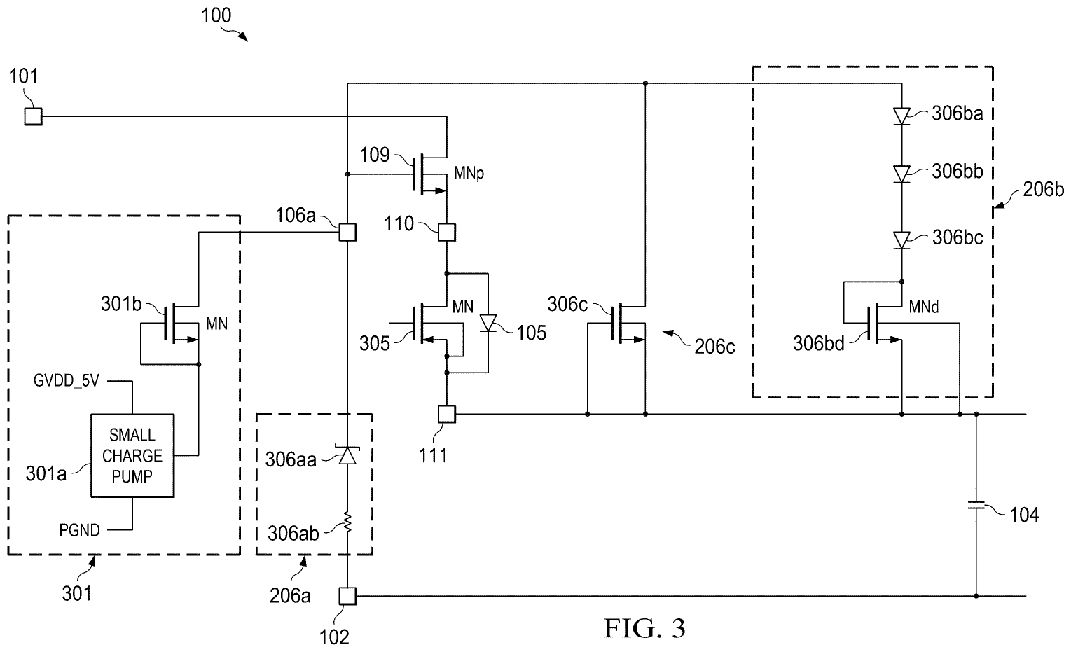

FIG. 3 illustrates examples of internal components of high impedance clamp circuit 206a, low impedance clamp circuit 206b, and precharge circuit 206c. Referring to FIG. 3, in at least one example, high impedance clamp circuit 206a comprises a Zener diode 306aa coupled in series with a resistor 306ab, where Zener diode 306aa is coupled to control terminal 106a and resistor 306ab is coupled to switching terminal 102. Series coupled Zener diode 306aa and resistor 306ab can set the gate voltage of pass transistor MNp 109 (voltage of control terminal 106a) with respect to switching terminal 102 to the second value when the voltage at switching terminal 102 is at a steady state and very little current flows through the series coupled Zener diode 306aa and resistor 306ab from the gate-drain parasitic capacitance (CGD) of pass transistor MNp 109. At this time, the voltage at boot terminal 111 is relatively high with respect to the voltage at control terminal 106a, and low impedance clamp circuit 206b can be largely inactive. In at least one example, resistor 306ab protects Zener diode 306aa from having a large voltage drop that may damage Zener diode 306aa. When HS switch MN_{HS} 107 is off (e.g., when LS switch MN_{LS} 108 is on during a low phase or when the half bridge is tri-stated), Zener diode 306aa defines the DC voltage between control terminal 106a and switching terminal 102. High impedance clamp circuit 206a provides a weak DC path and has high impedance between control terminal 106a and switching terminal 102, and draws very little transient current compared with low impedance clamp circuit 206b during the voltage transition at boot terminal 111/switching terminal 102.

In at least one example, low impedance clamp circuit 206b comprises a plurality of diodes 306ba, 306bb, and 306bc and a diode-connected transistor MNd 306bd. Plurality of diodes 306ba, 306bb, and 306bc are coupled in series where diode 306ba is coupled to control terminal 106a and diode 306bc is coupled to diode-connected transistor MNd 306bd, which is coupled to boot terminal 111. Low impedance clamp circuit 206b provides a low impedance path for a large current that flows through the CGD of pass transistor MNp 109 when the voltage at boot terminal 111 (and the voltage at switching terminal 102) is in a transition state right after the high side switch is turned off, and very little current flows to high impedance clamp 206a. As the current flows through low impedance clamp circuit 206b, a large voltage based on a sum of the forward voltages of the diodes 306ba, 306bb and 306bc, as well as the threshold voltage of the diode-connected transistor MNd 306bd, can be developed across Low impedance clamp circuit 206b. The VGS voltage of the pass transistor MNp 109 can have the first value close to the voltage across Low impedance clamp circuit 206b, with the sum of the forward voltages of the diodes setting the overdrive voltage of the pass transistor MNp 109 to reduce the impedance of MNp 109, thereby reducing the power loss by maximizing (or at least facilitating) charge transfer while the voltage across the pass transistor MNp 109 is low. Low impedance clamp circuit 206b can also clamp the VGS voltage at the first value, even if the current through Low impedance clamp circuit 206b continues increasing, to maintain the VGS voltage within the voltage stress limit of the pass transistor MNp 109. When the voltage at switching terminal 102/boot terminal 111 is at the steady state, the voltage difference between control terminal 106a and boot terminal 111 is relatively small and can be lower than the sum of forward voltages of the diodes, therefore low impedance clamp 206b can be largely inactive, and high impedance clamp 206a can define the gate voltage of pass transistor 109.

While the example of FIG. 3 illustrates three series connected diodes, any number of diodes may be connected in series based on, for example, a target overdrive voltage, and the voltage stress limit of the pass transistor MNp 109.

In at least one example, one or more of plurality of diodes 306ba, 306bb, or 306bc or diode-connected transistor MNd 306bd can be replaced by a Zener diode which is larger than Zener diode 306aa so that it can provide a low impedance path for Low impedance clamp circuit 206b. In at least one example, transistor MNd 306bd is a GaN device made in a GaN processing node, and the plurality of diodes 306ba, 306bb, or 306bc can be off-die (or off-chip) diodes.

In at least one example, power converter 100 includes a startup circuit 301, which charges control terminal 106a when power converter 100 is turned on or enabled. For instance, when there is no voltage on the top plate of bootstrap capacitor 104, an initial voltage is developed across bootstrap capacitor 104 by charging control terminal 106a via startup circuit 301, which in turn causes pass transistor MNp 109 to charge boot terminal 111. In at least one example, after control terminal 106a is pre-charged, startup circuit 301 may be disabled to save power. In at least one example, startup circuit 301 comprises a charge pump 301a coupled between a local supply rail GVVD (e.g., 5V) and ground. In at least one example, an output of charge pump 301a is coupled to a diode-connected transistor MN 301b, which in turn is coupled to control terminal 106a.

In at least one example, diode 105 is a parasitic diode of transistor MN 305 between current terminal 110 and boot terminal 111, where MN 305 is a p-type transistor. When HS switch MN_{HS} 107 is on, voltage on boot terminal 111 is higher than voltage on power supply terminal 101 or Vin. Pass transistor MNp 109 has a body diode that can cause current flow from boot terminal 111 to power terminal 101. This current is blocked from discharging bootstrap capacitor 104 by the parasitic diode of transistor MN 305. In at least one example, transistor MN 305 is replaced with a diode having a cathode terminal coupled to boot terminal 111.

In at least one example, pre-charge circuit 206c comprises n-type transistor MNpc 306c, which is diode-connected having a gate terminal coupled to boot terminal 111 and drain and source terminals coupled to control terminal 106a and boot terminal 111, respectively. In at least one example, pre-charge circuit 206c pre-charges control terminal 106a when HS switch MN_{HS} 107 is on and LS switch MN_{LS} 108 is off. The diode-connected transistor MN pc 306c can set the voltage of control terminal 106a to one transistor threshold voltage (Vt) of MNpc 306c below the voltage of boot terminal 111. As described above, with such arrangements, the pass transistor MNp 109 can be enabled and operate in linear mode, thereby bringing the voltage at current terminal 110 to the voltage at power supply terminal 101 (V in). Such arrangements can reduce the voltage across transistor MN 305 and allow transistor MN 305 to be implemented in a low voltage device.

In at least one example, transistor MNp 109 is a high voltage device such as one of an LDMOS FET, a drain extended n-type metal oxide semiconductor (DENMOS) FET, a complementary MOS (CM OS) based NM OS, or a GaN. Other transistors in FIG. 3 may operate at a lower voltage provided by bootstrap capacitor 104 and other low power supply rails and can be low voltage devices.

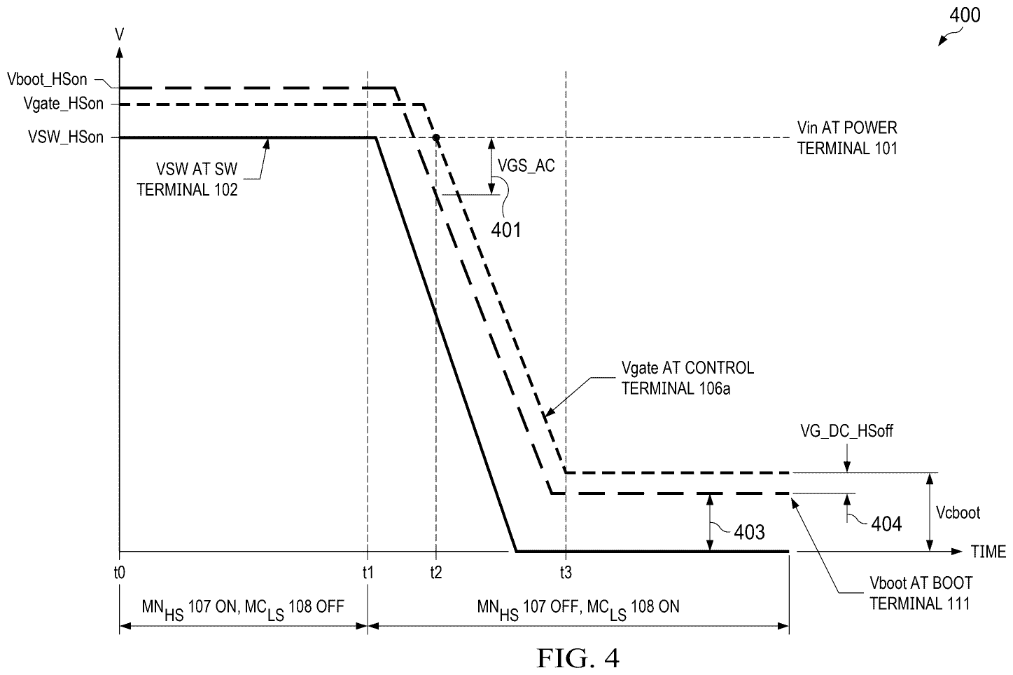

FIG. 4 is a plot 400 illustrating a timing diagram of signals of the power converter to charge the bootstrap capacitor, in accordance with at least one example. Here, x-axis is time and y-axis is voltage, Vgate_H Son represents the voltage at control terminal 106a when HS switch MN_{HS} 107 is on, Vboot_HSon represents the voltage at boot terminal 111 (e.g., at the top plate of bootstrap capacitor 104) when HS switch MN_{HS} 107 is on, VSW_HSon represents the voltage at switching terminal 102 when HS switch MN_{HS} 107 is on, and 401 represents VGS of pass transistor MN p 109 during the voltage transition of switching terminal 102 and boot terminal 111. Also, 403 denotes the voltage across bootstrap capacitor 104 (also labelled Vcboot) when the voltage transition ends and after the charging finishes, and 404 denotes the DCVG of pass transistor MN p 109 with respect to the switching terminal voltage (also labelled VG_DC_HSoff) when the voltage transition ends.

Between t0 and t1, when HS switch MN_{HS} 107 is on and LS switch MN_{LS} 108 is off, precharge circuit 206c sets the voltage of control terminal 106a to Vgate_HSon. As explained above, pass transistor MNp 109 is turned on and brings the voltage at current terminal 110 to Vin, thereby reducing the voltage across diode 105.

At t1, HS switch MN_{HS} 107 turns off resulting in an AC event where the voltage of switching terminal 102 falls. The voltage on switching terminal 102 tracks the voltage on boot terminal 111, where the two voltages are separated by a voltage difference representing the amount of charge stored in bootstrap capacitor 104. As the voltage on switching terminal 102 falls during the AC event (e.g., between t1 and t3), the voltage on boot terminal 111 also follows with the voltage on switching terminal 102. Between t0 and t1, voltage on boot terminal 111 is higher than the voltage on power terminal 101 because of bootstrap capacitor 104.

Because of the weak DC path through series coupled Zener diode 306aa and resistor 306ab, little to no current flows during the A C event from control terminal 106a to switching terminal 102 via High impedance clamp circuit 206a. As the voltage on switching terminal 102 falls during the AC event, current flows from power terminal 101 (e.g., Vin) to control terminal 106a via parasitic drain-to-gate capacitance (CDG) of pass transistor MNp 109. This current that flows through CDG into control terminal 106a, finds a low impedance path in low impedance clamp circuit 206a, and flows to boot terminal 111 through plurality of diodes 306ba, 306bb, and 306bc, and a diode-connected transistor MNd 306bd. The flow of current through the diodes and the diode-connected transistor creates a voltage across low impedance clamp circuit 206a between control terminal 106a and boot terminal 111, and that voltage can set the VGS of pass transistor MNp 109, represented by 401 in FIG. 3 That voltage can exceed the threshold voltage of pass transistor MNp 109 by an overdrive voltage set by a sum of the forward voltages of the diodes. The increased overdrive voltage can facilitate flow of charge while the VDS of pass transistor MNp 109, defined by the voltage difference between Vin at power terminal 101 and the voltage at boot terminal 111, remains low at the initial portion of the voltage transition (e.g., at time t2). Therefore, maximizing transfer of charge at that time can reduce the power loss at pass transistor MNp 109 caused by the charge transfer. Low impedance clamp circuit 206a also clamps the VGS of pass transistor MNp 109 to avoid overstressing pass transistor MNp 109, as described above.

At time t3 and onwards, when HS switch MN_{HS} 107 is off (e.g., when LS switch MN_{LS} 108 is on during a low phase or when the half bridge is tri-stated), Zener diode 306aa defines the DC voltage between control terminal 106a and switching terminal 102. At time t3, the AC event completes and the parasitic CDG becomes an open capacitor in DC. As a result, the current stops flowing from power terminal 101 to control terminal 106a via the parasitic CDG and stops flowing into Low impedance clamp circuit 206b. Slowly, high impedance clamp circuit 206a sets a voltage at control terminal 106a as indicated by time t3 with respect to the voltage at switching terminal 102, as well as VG_DC_HSoff (404). The VG_DC_HSoff voltage can also set the voltage difference across bootstrap capacitor 104, thereby clamping/limiting the voltage difference.

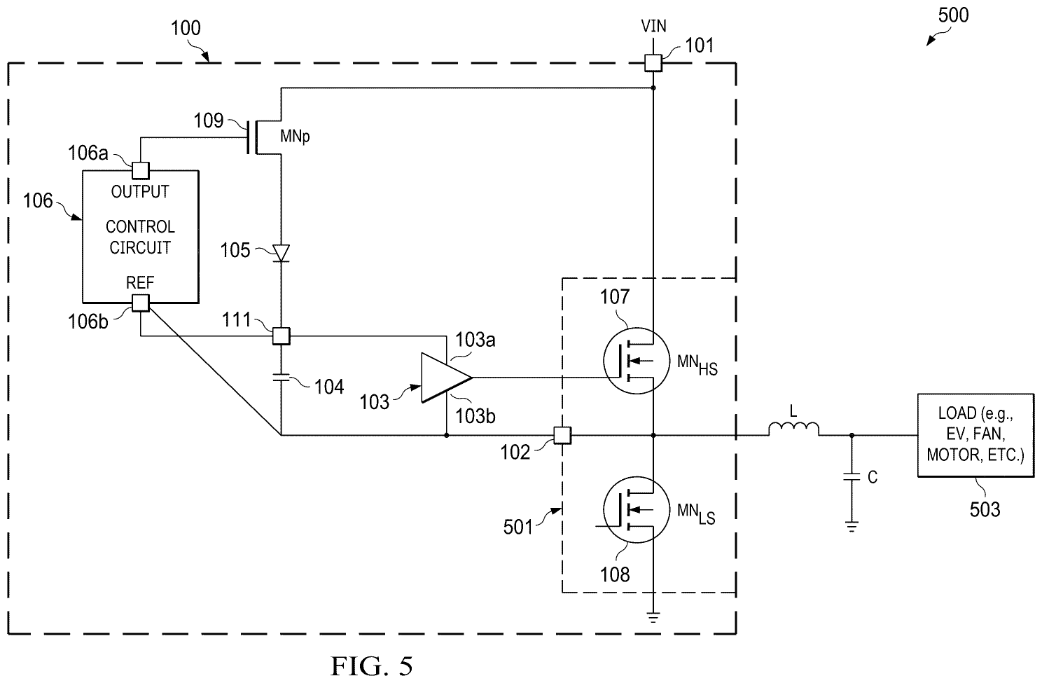

FIG. 5 is a schematic of a system 500 comprising DC-DC buck power converter 100 with the circuitry to charge a bootstrap capacitor, in accordance with at least one example. In at least one example, system 500 further comprises an inductor L, a capacitor C, and a load 503 coupled to DC-DC buck power converter 100 having a bridge 501 including high side switch MN_{HS} 107 and low side switch MN_{LS} 108 coupled between power terminal 101 and ground. Inductor L has one end coupled to switching terminal 102 and another end coupled to the capacitor C, which is also coupled to ground. Load 503 is coupled to the capacitor C. Load 503 can be any suitable load such as an electric vehicle (EV), a fan, a motor, etc. Driver circuit 103 is coupled to high side switch MN_{HS} 107, with driver supply terminal 103a coupled to boot terminal 111 and driver reference terminal 103b coupled to switching terminal 102, and bootstrap capacitor 104 is coupled between boot terminal 111 and switching terminal 102. Pass transistor MNp 109 and diode 105 is coupled between power terminal 101 and boot terminal 111, and control circuit 106 is coupled between control terminal 106a of pass transistor MNp 109 and at least one of boot terminal 111 and switching terminal 102.

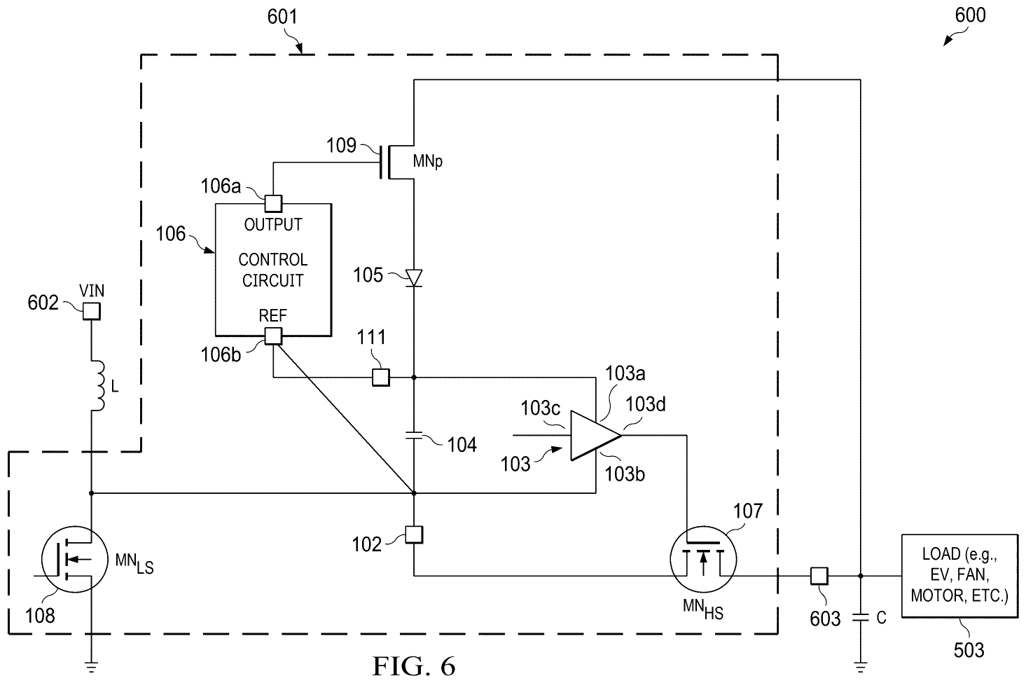

FIG. 6 is a schematic of a system 600 comprising DC-DC boost power converter 601 with the circuitry to charge a bootstrap capacitor, in accordance with at least one example. Boost power converter 601 has inductor L coupled between an input power terminal 602 and switching terminal 102, low side switch MN_{LS} 108 coupled between switching terminal 102 and ground, and high side switch MN_{HS} 107 coupled between power output 603 and switching terminal 102, and capacitor C and load 503 coupled to power output 603. Driver circuit 103 is coupled to high side switch MN_{HS} 107, with driver supply terminal 103a coupled to boot terminal 111 and driver reference terminal 103b coupled to switching terminal 102, and bootstrap capacitor 104 is coupled between boot terminal 111 and switching terminal 102. Pass transistor MNp 109 and diode 105 is coupled between power output 603 and boot terminal 111, and control circuit 106 is coupled between control terminal 106a of pass transistor MNp 109 and at least one of boot terminal 111 and switching terminal 102.

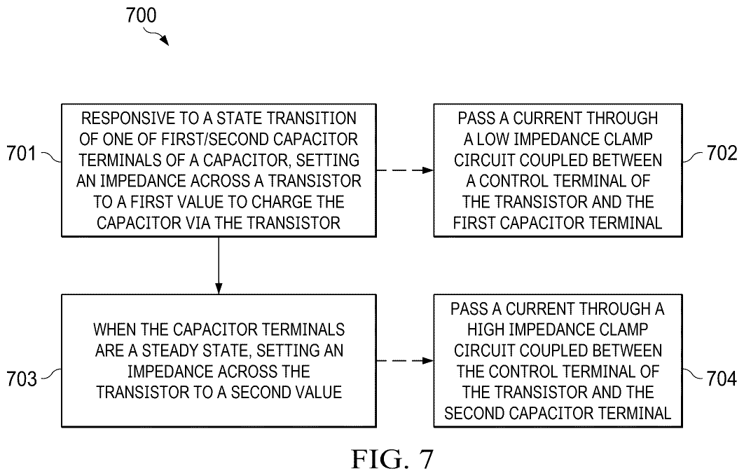

FIG. 7 is a flowchart 700 of a method of charging the bootstrap capacitor, in accordance with at least one example. At block 701, responsive to a state transition of the top plate of bootstrap capacitor 104, setting an impedance across pass transistor MNp 109 to a first value to charge bootstrap capacitor 104 via pass transistor MNp 109. At block 702, the impedance across pass transistor MNp 109 is set to the first value by setting a first voltage across control terminal 106a and current terminal 110 of pass transistor MNp 109. At block 703, an impedance across pass transistor MNp 109 is set to a second value, where the second value is higher than the first value. The impedance can be set to a second value when, for example, the top plate of bootstrap capacitor 104 is at a steady state, or the charging of bootstrap capacitor 104 completes. At block 704, the impedance across pass transistor MNp 109 is set to the second value by setting a second voltage at control terminal 106a of pass transistor MNp 109 relative to the switching terminal, which also clamps the voltage across bootstrap capacitor 104. In at least one example, the first voltage is set across control terminal 106a and current terminal 110 of pass transistor MNp 109 by passing a current from boot terminal 111/switching terminal 102 to low impedance clamp circuit 206b. In at least one example, the second voltage is set across control terminal 106a and current terminal 110 by passing a current from boot terminal 111/switching terminal 102 to high impedance clamp circuit 206a, with low impedance clamp circuit 206b inactive.

The following are additional examples provided in view of the above-described implementations. Here, one or more features of example, in isolation or in combination, can be combined with one or more features of one or more other examples to form further examples also falling within the scope of the disclosure. As such, one implementation can be combined with one or more other implementations without changing the scope of disclosure.

Example 1 is an apparatus comprising: a driver circuit having a driver supply terminal, a driver reference terminal, and a driver output; a transistor coupled between a power terminal and the driver supply terminal; and a transistor control circuit coupled between a control terminal of the transistor and at least one of the driver supply terminal or the driver reference terminal.

Example 2 is an apparatus according to any example herein, in particular example 1, further comprising a capacitor coupled between the driver supply terminal and the driver reference terminal.

Example 3 is an apparatus according to any example herein, in particular example 1, wherein the transistor control circuit includes a clamp circuit coupled between the control terminal and at least one of the driver supply terminal or the driver reference terminal.

Example 4 is an apparatus according to any example herein, in particular example 3, wherein the clamp circuit is configurable to set a voltage between the control terminal and a current terminal of the transistor to a value responsive to the at least one of the driver supply terminal or the driver reference terminal being in a changing state.

Example 5 is an apparatus according to any example herein, in particular example 4, wherein the clamp circuit is coupled between the control terminal and the driver supply terminal.

Example 6 is an apparatus according to any example herein, in particular example 3, wherein the transistor is a first transistor, and the clamp circuit includes multiple diodes and a diode-connected second transistor.

Example 7 is an apparatus according to any example herein, in particular example 3, wherein the clamp circuit includes a Zener diode.

Example 8 is an apparatus according to any example herein, in particular example 3, wherein the clamp circuit includes a switch, and the transistor control circuit is configurable to enable the switch responsive to a state of the driver circuit.

Example 9 is an apparatus according to any example herein, in particular example 4, wherein the clamp circuit is a first clamp circuit, and the transistor control circuit includes a second clamp circuit coupled between the control terminal and the at least one of the driver supply terminal or the driver reference terminal.

Example 10 is an apparatus according to any example herein, in particular example 9, wherein the value is a first value, and the second clamp circuit is configurable to set the voltage to a second value responsive to the at least one of the driver supply terminal or the driver supply terminal being in a steady state.

Example 11 is an apparatus according to any example herein, in particular example 9, wherein the second clamp circuit includes a Zener diode and a resistor coupled between the control terminal and the driver reference terminal.

Example 12 is an apparatus according to any example herein, in particular example 10, wherein the transistor has a first resistance with the voltage being at the first value, the transistor has a second resistance with the voltage being at the second value, and the first resistance is lower than the second resistance.

Example 13 is an apparatus according to any example herein, in particular example 3, wherein the transistor control circuit includes a circuit coupled between the control terminal and the driver supply terminal and configurable to transfer charge from the driver supply terminal to the control terminal.

Example 14 is an apparatus according to any example herein, in particular example 13, wherein the transistor is a first transistor, and the circuit includes a diode-connected second transistor.

Example 15 is an apparatus according to any example herein, in particular example 1 further comprising a high side switch coupled between the power terminal and the driver reference terminal, wherein the driver output is coupled to a control input of the high side switch.

Example 16 is an apparatus according to any example herein, in particular example 15 further comprising a low side switch coupled between the driver reference terminal and a ground, wherein the low side switch is coupled in series with the high side switch.

Example 17 is a system comprising: a DC-DC converter; an inductor coupled to the DC-DC converter; a load capacitor coupled to the inductor; and a load coupled to the load capacitor, wherein the DC-DC converter comprises: a driver circuit having a driver supply terminal, a driver reference terminal, and a driver output; a transistor coupled between a power terminal and the driver supply terminal; a transistor control circuit coupled between a control terminal of the transistor and at least one of the driver supply terminal or the driver reference terminal; and a high switch coupled between the power terminal and the driver reference terminal, wherein the driver output is coupled to a control input of the high side switch.

Example 18 is a system according to any example herein, in particular example 17, wherein the DC-DC converter is configurable as a buck converter.

Example 19 is a system according to any example herein, in particular example 17, wherein the DC-DC converter is configurable as a boost converter.

Example 20 is a system according to any example herein, in particular example 17, wherein the DC-DC converter comprises a capacitor coupled between the driver supply terminal and the driver reference terminal.

Example 21 is a system according to any example herein, in particular example 17, wherein the DC-DC converter comprises a low side switch coupled between the driver reference terminal and a ground, wherein the low side switch is coupled in series with the high side switch.

Example 22 is a method comprising: responsive to a state transition of a capacitor terminal of a capacitor, setting a first resistance across a transistor to a first value to charge the capacitor via the transistor; and responsive to the capacitor terminal being at a steady state, setting a second resistance across the transistor to a second value, in which the second value is higher than the first value.

Example 23 is a method according to any example herein, in particular example 22, wherein setting the first resistance across the transistor to the first value includes setting a first voltage across a control terminal and a current terminal of the transistor, and setting the second resistance across the transistor to the second value includes setting a second voltage across the control terminal and the current terminal.

Example 24 is a method according to any example herein, in particular example 23, wherein setting the first voltage across the control terminal and the current terminal of the transistor includes enabling a clamp circuit coupled between the control terminal and the capacitor terminal.

Example 25 is a method according to any example herein, in particular example 24, wherein the capacitor terminal is a first capacitor terminal, the clamp circuit is a first clamp circuit, and setting the second voltage across the control terminal and the current terminal includes enabling a second clamp circuit coupled between the control terminal and a second capacitor terminal of the capacitor.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” or “configurable to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuit or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuit. For example, a field effect transistor (“FET”) (such as an n-channel FET (N FET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN), or a gallium arsenide substrate (GaAs).

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” or “substantially” preceding a parameter means being within +/−10 percent of that parameter or, if the parameter is zero, a reasonable range of values around zero.

What is claimed is:

1. An apparatus comprising:
a driver circuit having a driver supply terminal, a driver reference terminal, and a driver output;
a transistor coupled between a power terminal and the driver supply terminal; and
a transistor control circuit coupled between a control terminal of the transistor and at least one of the driver supply terminal or the driver reference terminal.

2. The apparatus of claim 1, further comprising a capacitor coupled between the driver supply terminal and the driver reference terminal.

3. The apparatus of claim 1, wherein the transistor control circuit includes a clamp circuit coupled between the control terminal and at least one of the driver supply terminal or the driver reference terminal.

4. The apparatus of claim 3, wherein the clamp circuit is configurable to set a voltage between the control terminal and a current terminal of the transistor to a value responsive to the at least one of the driver supply terminal or the driver reference terminal being in a changing state.

5. The apparatus of claim 4, wherein the clamp circuit is coupled between the control terminal and the driver supply terminal.

6. The apparatus of claim 3, wherein the transistor is a first transistor, and the clamp circuit includes multiple diodes and a diode-connected second transistor.

7. The apparatus of claim 3, wherein the clamp circuit includes a Zener diode.

8. The apparatus of claim 3, wherein the clamp circuit includes a switch, and the transistor control circuit is configurable to enable the switch responsive to a state of the driver circuit.

9. The apparatus of claim 4, wherein the clamp circuit is a first clamp circuit having a first impedance, and the transistor control circuit includes a second clamp circuit having a second impedance coupled between the control terminal and the driver reference terminal.

10. The apparatus of claim 9, wherein the value is a first value, and the second clamp circuit is configurable to set a voltage between the control terminal and the driver reference terminal to a second value based on the second impedance.

11. The apparatus of claim 9, wherein the second clamp circuit includes a Zener diode and a resistor coupled between the control terminal and the driver reference terminal.

12. The apparatus of claim 10, wherein the transistor has a first impedance with the voltage being at the first value, the transistor has a second impedance with the voltage being at the second value, and the first impedance is lower than the second impedance.

13. The apparatus of claim 3, wherein the transistor control circuit includes a circuit coupled between the control terminal and the driver supply terminal and configurable to transfer charge from the driver supply terminal to the control terminal.

14. The apparatus of claim 13, wherein the transistor is a first transistor, and the circuit includes a diode-connected second transistor.

15. The apparatus of claim 1 further comprising a high side switch coupled between the power terminal and the driver reference terminal, wherein the driver output is coupled to a control input of the high side switch.

16. The apparatus of claim 15 further comprising a low side switch coupled between the driver reference terminal and a ground, wherein the low side switch is coupled in series with the high side switch.

17. A system comprising:
a DC-DC converter;
an inductor coupled to the DC-DC converter;
a load capacitor coupled to the inductor; and
a load coupled to the load capacitor, wherein the DC-DC converter comprises:
a driver circuit having a driver supply terminal, a driver reference terminal, and a driver output;
a transistor coupled between a power terminal and the driver supply terminal;
a transistor control circuit coupled between a control terminal of the transistor and at least one of the driver supply terminal or the driver reference terminal; and
a high side switch coupled between the power terminal and the driver reference terminal, wherein the driver output is coupled to a control input of the high side switch.

18. The system of claim 17, wherein the DC-DC converter is configurable as a buck converter.

19. The system of claim 17, wherein the DC-DC converter is configurable as a boost converter.

20. The system of claim 17, wherein the DC-DC converter comprises a capacitor coupled between the driver supply terminal and the driver reference terminal.

21. The system of claim 17, wherein the DC-DC converter comprises a low side switch coupled between the driver reference terminal and a ground, wherein the low side switch is coupled in series with the high side switch.

22. A method comprising:
responsive to a state transition of a capacitor terminal of a capacitor, setting a first impedance across a transistor to a first value to charge the capacitor via the transistor; and
when the capacitor terminal is at a steady state, setting a second impedance across the transistor to a second value, in which the second value is higher than the first value.

23. The method of claim 22, wherein the capacitor terminal is a first capacitor terminal, setting the first impedance across the transistor to the first value includes setting a first voltage across a control terminal and a current terminal of the transistor, and setting the second impedance across the transistor to the second value includes setting a second voltage across the control terminal and a second capacitor terminal.

24. The method of claim 23, wherein setting the first voltage across the control terminal and the current terminal of the transistor is by a clamp circuit coupled between the control terminal and the first capacitor terminal.

25. The method of claim 24, wherein the clamp circuit is a first clamp circuit, and wherein setting the second voltage across the control terminal and the current terminal is by a second clamp circuit coupled between the control terminal and the second capacitor terminal of the capacitor.
